(19) United States
(12) Patent Application Publication
(10) Pub. No.: US 2024/0033551 A1
(43) Pub. Date: Feb. 1, 2024

(54) FIRE SUPPRESSION SYSTEM AND METHOD

(71) Applicant: Firebot, Inc., Lorton, VA (US)

(72) Inventor: Mark Steven BALDINO, Lorton, VA (US)

(21) Appl. No.: 18/044,119

(22) PCT Filed: Sep. 3, 2021
(86) PCT No.: PCT/US2021/049138

§ 371 Date: Mar. 6, 2023

Related U.S. Application Data
(60) Provisional application No. 63/074,675, filed on Sep. 4, 2020.

(51) Int. Cl. A62C 31/03; A62C 99/00; A62C 31/05; A62C 37/40

(52) U.S. Cl. CPC A62C 31/03; A62C 99/0027; A62C 31/05; A62C 37/40

(57) ABSTRACT

A spray system comprising a nozzle including an inlet body and an outlet body. The inlet body has an inlet surface that defines an inlet fluid channel that extends about an inlet flow axis through the inlet body from an inlet opening to a chamber opening. The outlet body has an outlet surface and a chamber surface. The outlet surface defines at least a portion of an outlet chamber and an in outlet fluid channel. The outlet chamber extends about an outlet flow axis from the chamber surface toward the outlet fluid channel. The outlet fluid channel extends about the outlet flow axis from an outlet opening toward the outlet chamber. The inlet fluid channel of the inlet body is in fluid communication with the outlet chamber of the outlet body via the chamber opening, and the inlet flow axis is spaced from the outlet flow axis.

### CROSS-REFERENCE TO RELATED APPLICATIONS

This application the priority to and benefit of U.S. Provisional Patent Application No. 63/074,674, filed on Sep. 4, 2020, titled “Fire Suppression System and Method,” the contents of which are hereby incorporated by reference herein.

### TECHNICAL FIELD

This application generally relates to fire extinguishing systems, and, more particularly, to a fixed fire extinguishing system that forms a spray of droplets from a stream of fluid.

### BACKGROUND

Fires cause extensive amounts of property damage and human harm every year. In particular, a large portion of fires start on electric or gas range stovetops and are caused by flammable liquids. Many systems exist for extinguishing fires, including handheld fire extinguishers and sprinkler systems. However, handheld fire extinguishers require manual actuation, while sprinkler systems cover a wide area, and can often destroy property during operation that extends well beyond the area affected by fire and may not be suited for electrical or grease fires. As a result, there is a need for a fire extinguishing system suited for small areas to reduce fire damage and more accurately spray fires to decrease fire extinguishing time.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

An embodiment of the present invention includes a spray system that may be a component of a fixed fire extinguishing system used in detecting and neutralizing a fire. The spray system includes a body that defines at least one fluid inlet, at least one fluid outlet, and at least one flow channel. The body includes a first end and a second end spaced from each along a central axis. The at least one fluid inlet is spaced between the first and second ends, and the at least one fluid outlet is spaced between the at least one fluid inlet and either the first or second end of the body. The body is defined by a top and bottom surface and four side surfaces. The top surface defines the at least one fluid outlet and the bottom surface defines the at least one fluid inlet such that the at least one fluid inlet and the at least one fluid outlet are spaced from each other in the vertical direction. The at least one flow channel extends along a central flow axis between the at least one fluid inlet and the at least one fluid outlet, such that the at least one fluid inlet is in fluid communication with the at least one fluid outlet via the at least one flow channel. The at least one flow channel includes an inlet section and an outlet section. The central flow axis may be at least partially offset from the central axis, for example, the central flow axis is in-line with the central axis at the inlet section of the flow channel and offset at the outlet section. The inlet section extends from the at least one fluid inlet to the outlet section, and the outlet section extends from the inlet section to the at least one fluid outlet along a central flow axis. The inlet section has a substantially constant width that extends in the transverse direction. In an embodiment, the inlet section has a substantially constant cross-sectional area, and outlet section's cross-sectional area decreases from the inlet section toward the fluid outlet. The spray system is configured to facilitate the transfer of fluid, for example, water and at least one fire-suppressant additive, from the at least one fluid inlet to the at least one fluid outlet via the at least one flow channel.

In another embodiment, the outlet section defines a swirl chamber extending about a vertical axis that also extends through a center of the fluid outlet, and the cross-sectional area of the outlet section decreases from the fluid inlet to the swirl chamber. The swirl chamber is further defined by a side chamber wall, and the outlet section is further defined by a first and second side wall. A portion of the side chamber intersects tangentially with a first side wall of the outlet portion. The swirl chamber may be further defined by an upper chamber wall that includes at least one spoke, for example, three spokes. The spoke extends through the vertical axis of the swirl chamber from a first location on the upper chamber wall to a second location, where the first and second locations located at substantially the same vertical positions within the swirl chamber. The spokes may be arranged with spacing as desired, for example, equally around the upper chamber wall at substantially the same vertical position within the swirl chamber. The shape of the outlet section of the flow channel may be configured to create a turbulent vortex of a fluid when the fluid enters the outlet section of the at least one flow channel from the inlet section at a pressure. The turbulent vortex of a fluid then passes through the swirl chamber and exits the at least one fluid outlet in a conical shape at a conical angle.

In another embodiment, the body defines a single fluid inlet, a single fluid outlet, and a single flow channel, such that the spray system is configured to facilitate the transfer of fluid from the fluid inlet to the outlet via the flow channel.

A further embodiment, the body defines a single flow channel, a single fluid inlet, and two fluid outlets where the fluid inlet and outlets are spaced from each other along the central flow axis, for example, the fluid inlet is spaced unequally between the two fluid outlets along the central flow axis.

In a further embodiment, a fire suppressant can be expelled through a nozzle attached to a suppressant container or bag. The nozzle can be configured such that it contains at least one hole that can be threaded or non-threaded such that a screw, a clip or other device can be used to secure the nozzle to a fire suppressant device. The at least one hole can help secure the nozzle to the device and can additionally enable adjustment of the nozzle spray direction. The nozzle can include, for example, a barbed fitting, a screw fit, a star arrangement push and twist fit, a push fit locking clip, or a two piece for injection molding and fusing.

The nozzle can be configured such that the direction, angle, and spray area is adjustable so as to enable the fire suppressant device to be fitted to a variety of environments comprising extractor hood, an overhead microwave, and a stovetop configuration in terms of height to the stovetop and a fire coverage area. The nozzle can also be extendable past a body of the fire suppressant device via tubing to provide for more accurate dispensing of suppressant spray pattern.

In addition, the nozzle may have a plug, a cover, or other device that covers the nozzle outlet until activated. The cover can prevent build up and hardening of grease or other materials inside the nozzle and prevent the flow of suppressant. The cover can be attached or detached, a single use or multi use item such as a rubber plug, a film designed to be torn or an arm that covers it, or other type of cover to prevent materials from inadvertently entering the nozzle.

### BRIEF DESCRIPTION OF THE DRAWINGS

The foregoing summary, as well as the following detailed description, will be better understood when read in conjunction with the appended drawings. The drawings show illustrative embodiments of the invention. It should be understood, however, that the application is not limited to precise arrangements and instrumentalities shown.

FIG. 1A illustrates a top view of a spray system, according to an aspect of this disclosure.

FIG. 1B illustrates a perspective view of a spray system, according to an aspect of this disclosure.

FIG. 1C illustrates a cross sectional side view of an inlet section and a sealing groove of the spray system taken along line A-A shown in FIG. 1A, according to an aspect of the disclosure.

FIG. 1D illustrates a cross sectional side view of an outlet section and a sealing groove of the spray system taken along line B-B shown in FIG. 1A, according to an aspect of the disclosure.

FIG. 1E illustrates a top view of a swirl chamber, according to an aspect of the disclosure.

FIG. 1F illustrates a cross sectional view of a swirl chamber taken along line C-C shown in FIG. 1E, according to an aspect of the disclosure.

FIG. 1G illustrates a bottom view of a spray system, according to an aspect of the disclosure.

FIG. 2 illustrates a top view of a cover, according to an aspect of this disclosure.

FIG. 3 illustrates a top view of a spray system, according to an aspect of this disclosure.

FIG. 4 illustrates a top view of a spray system, according to an aspect of this disclosure.

FIG. 5 illustrates a top view of a spray system, according to another aspect of this disclosure.

FIG. 6 illustrates a perspective view of the spray system shown in FIG. 5.

FIG. 7 illustrates a cross-sectional view of the spray system shown in FIG. 5 taken along line 7-7.

FIG. 8 illustrates a cross-sectional view of the spray system shown in FIG. 5 taken along line 8-8.

FIG. 9 illustrates an exploded perspective view of a nozzle assembly, according to an aspect of this disclosure.

FIG. 10 illustrates a collapsed perspective view of the nozzle assembly shown in FIG. 9.

FIG. 11 illustrates a bottom view of the nozzle assembly shown in FIG. 9.

FIG. 12 illustrates a side view of the nozzle assembly shown in FIG. 9.

FIG. 13 illustrates another side view of the nozzle assembly shown in FIG. 9.

FIG. 14 illustrates a cross-sectional view of the nozzle assembly shown in FIG. 13 taken along line A-A.

FIG. 15 illustrates a bottom view of the nozzle assembly shown in FIG. 9

FIG. 16 illustrates a cross-sectional view of the nozzle assembly shown in FIG. 15 taken along line B-B.

FIG. 17 illustrates a top view of a nozzle cap, according to an aspect of this disclosure.

FIG. 18 illustrates a side view of the nozzle cap shown in FIG. 17.

FIG. 19 illustrates a bottom view of the nozzle cap shown in FIG. 17.

FIG. 20 illustrates a perspective view of a nozzle plug, according to an aspect of this disclosure.

FIG. 21 illustrates a top view of the nozzle plug shown in FIG. 20.

FIG. 22 illustrates side view of the nozzle plug shown in FIG. 20.

FIG. 23 illustrates a schematic of a fixed fire extinguishing system, according to an aspect of the disclosure.

FIG. 24 illustrates a fixed fire extinguishing system, according to an aspect of the disclosure.

FIG. 25 illustrates a schematic of a spray system, according to an alternative aspect of this disclosure.

FIG. 26 illustrates a schematic of a spray system, according to another alternative aspect of this disclosure.

FIG. 27 illustrates a schematic of a spray system, according to another alternative aspect of this disclosure.

### DETAILED DESCRIPTION

The disclosure generally relates to a spray system used in fixed fire extinguishing systems 10, such as a fire extinguishing system 10 designed for residential use. For example, during a stovetop fire in a residential setting, fluid may be delivered to a spray system 100 above the stovetop. The spray system 100 may then transform the delivered fluid into a spray of droplets over top of the stove to contribute to the extinguishment of a fire. The fire extinguishing system 10 described herein can also be referred to as an adjustable density misting delivery system (AMDS).

Certain terminology used in this description is for convenience only and is not limiting. The words “axial”, “radial”, “outward”, “inward”, “top”, “bottom”, “upper,” and “lower” designate directions in the drawings to which reference is made. The term “substantially” is intended to mean considerable in extent or largely but not necessarily wholly that which is specified. All ranges disclosed herein are inclusive of the recited endpoint and independently combinable (for example, the range of “from 2 grams to 10 grams” is inclusive of the endpoints, 2 grams and 10 grams, and all the intermediate values). The terminology includes the above-listed words, derivatives thereof and words of similar import.

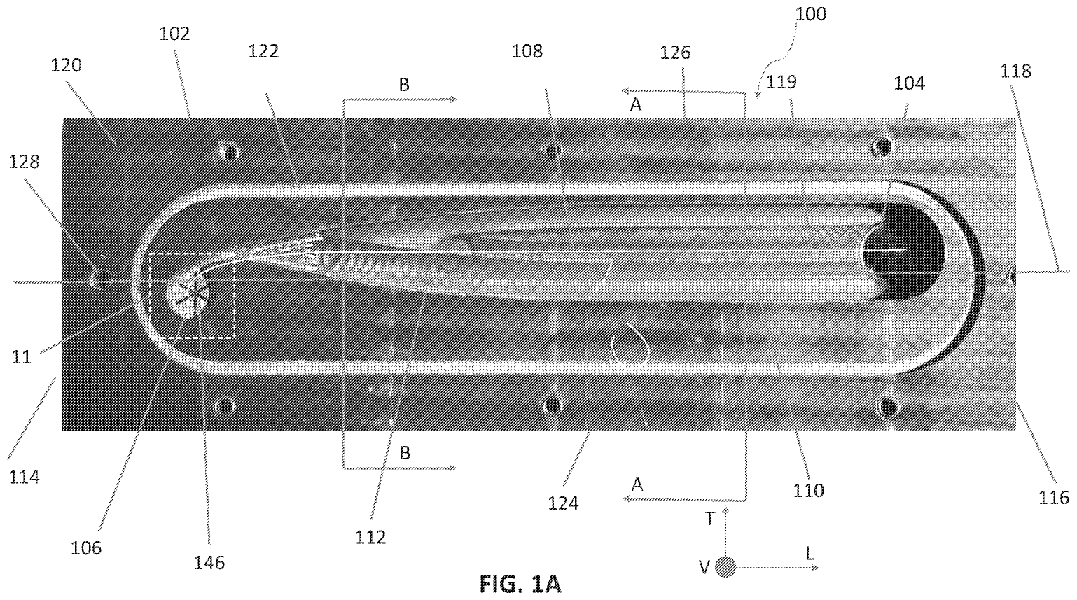

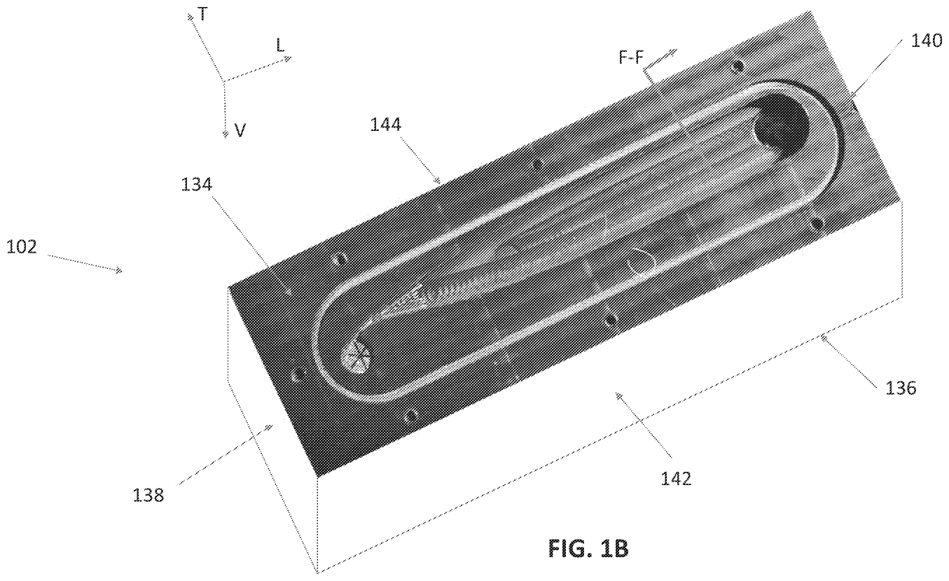

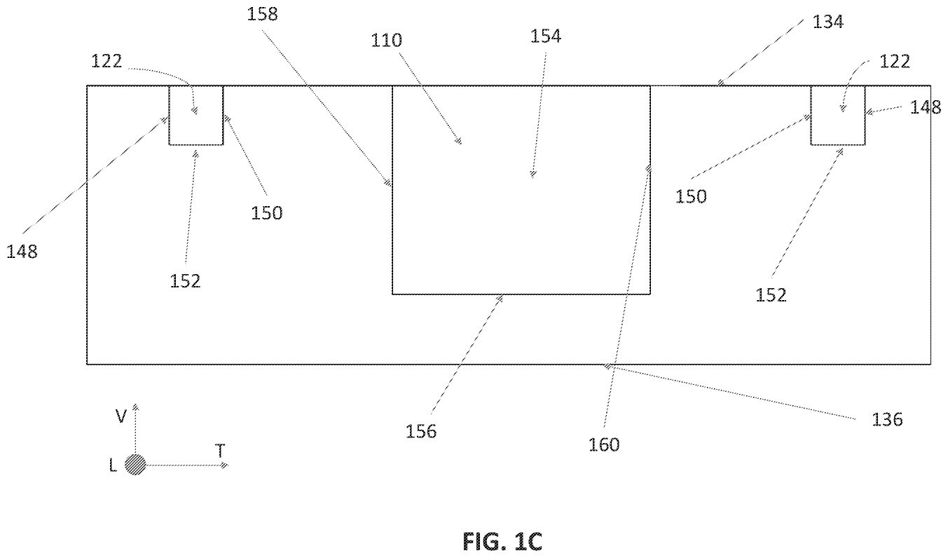

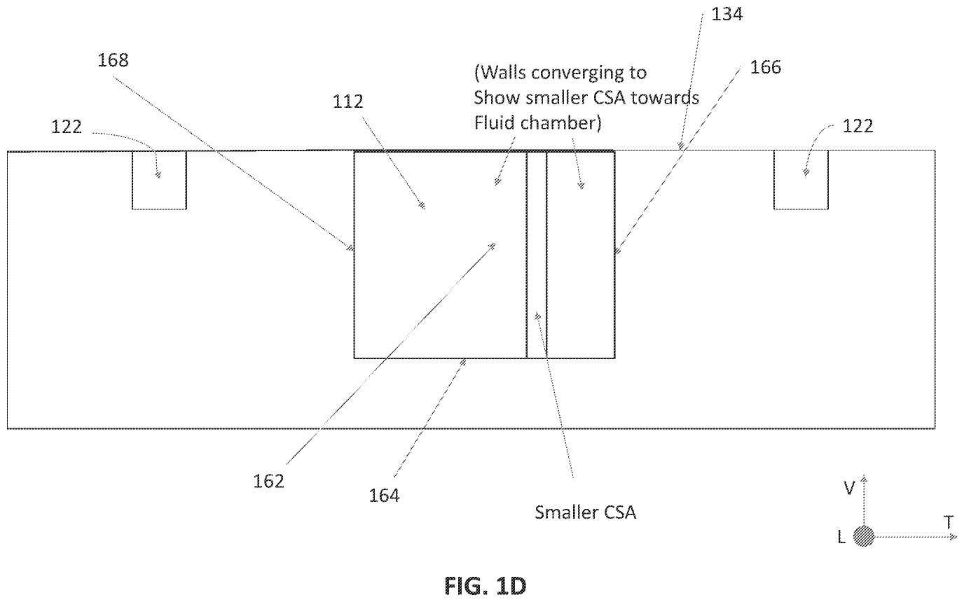

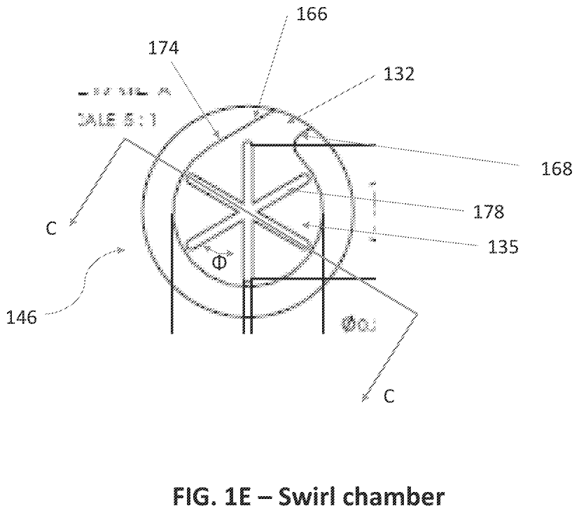

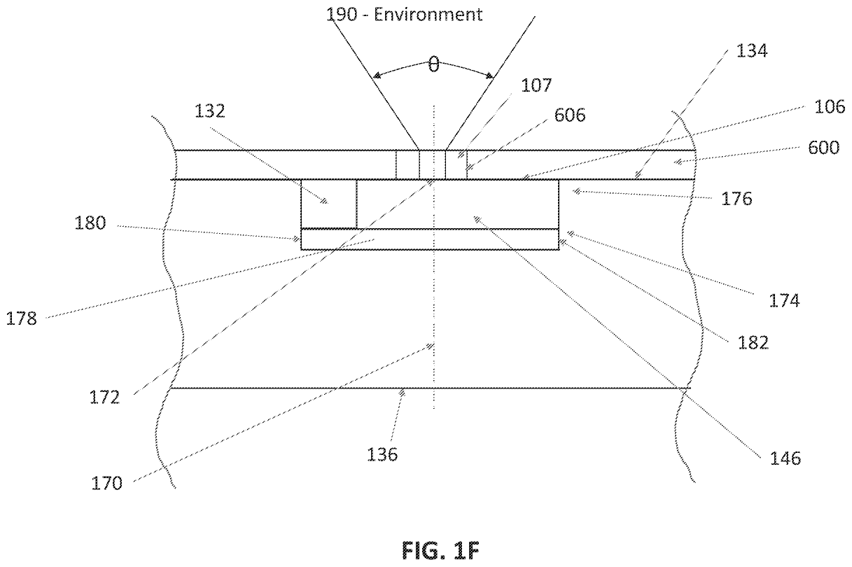

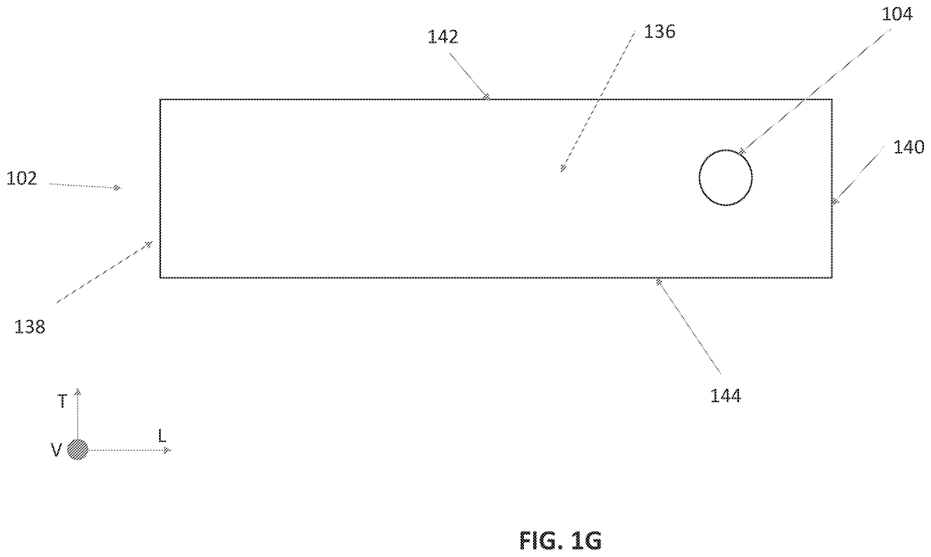

FIG. 1A illustrates a top view of a spray system 100, according to an aspect of this disclosure. The spray system 100 includes a body 102 that defines at least one fluid inlet 104, at least one fluid outlet 106, and at least one flow channel 108. A fluid may flow through the spray system 100, entering through the at least one fluid inlet 104, traveling through the at least one flow channel 108, and exiting through the at least one fluid outlet 106 towards the environment. After entering the spray system 100, the fluid may transform to a turbulent vortex to create a spray of droplets exiting from the at least one fluid outlet 106 of the system 100. In an aspect, the at least one fluid outlet 106 can include a nozzle 107.

The at least one flow channel 108 may include a single flow channel 108, the at least one fluid inlet 104 may include a single fluid inlet 104, and the at least one fluid outlet 106 may include a single fluid outlet 106. In an aspect, the at least one flow channel 108 may include more than a single flow channel. For example, the at least one flow channel 108 may include multiple flow channels that extend between the at least one fluid inlet 104 and the at least one fluid outlet 106. In another example, the at least one flow channel 108 may include two channels that extend from a single fluid inlet 104 to two separate fluid outlets 106.

The body 102 (e.g. nozzle bar) includes a first end 114 and a second end 116, wherein the second end 116 is spaced from the first end 114 along a central axis 118 that extends in a longitudinal direction L. The at least one fluid inlet 104 is positioned between the first and second ends 114 and 116. The at least one fluid outlet 106 is positioned between the at least one fluid inlet 104 and either the first end 114 or the second end 116 of the body 102. The at least one fluid inlet 104 may be spaced from the at least one fluid outlet 106 in a vertical direction V, wherein the vertical direction V is substantially perpendicular to the longitudinal direction L.

FIG. 1B illustrates a top perspective view of the spray system 100 shown in FIG. 1A. The body 102 of the spray system 100 has a top surface 134 and a bottom surface 136 spaced from the top surface 134 in the vertical direction V. The top surface 134 may define the at least one fluid outlet 106, and the bottom surface 136 may define the at least one fluid inlet 104. The body 102 further has a first side surface 138 and a second side surface 140 spaced from the first side surface 138 in the longitudinal direction L. The body 102 further has a third side surface 142 and a fourth side surface 144 spaced from the third side surface 142 in a transverse direction T. The transverse direction T is substantially perpendicular to the longitudinal direction L and the vertical direction V.

FIGS. 1C and 1D illustrate a cross sectional side view of a sealing groove of a spray system taken along line A-A and B-B shown in FIG. 1B. The body 102 may further define a sealing groove 122. The sealing groove 122 may include an outer side wall 148 and an inner side wall 150, wherein the outer side wall 148 is spaced from the inner side wall 150 by a bottom wall 152 of the groove 122. The inner and outer side walls 150 and 148 may extend in the vertical direction from the bottom wall 152 of the sealing groove 122 to the top surface 134 of the body 102. A gasket (not pictured) may be configured to sit in the groove 122, such that the gasket may be compressed to form a seal when the top surface 134 is coupled to a surface, for example, a portion of fixed fire extinguishing system 10 or a corresponding cover 600.

In an aspect, the top surface 134 may define a plurality of holes 128 that extend in the vertical direction V to the bottom surface 136, where the holes 128 are configured to allow the system 100 to be coupled to a fixed fire extinguishing system 10, by for example, becoming integral with or releasably attached to a housing 15 of a fixed fire extinguishing system 10. Additionally, or alternatively, the holes 128 may be configured to allow the body 102 to be coupled to a corresponding cover 600.

Referring again to FIG. 1A, the at least one flow channel 108 extends between the at least one fluid inlet 104 and the at least one fluid outlet 106, such that the at least one fluid inlet 104 is in fluid communication with the at least one fluid outlet 106 via the at least one flow channel 108. The at least one flow channel 108 may further include an inlet section 110 and an outlet section 112. The inlet section 110 may extend along a central flow axis 119. The central flow axis 119 extends from the at least one fluid inlet 104 to the at least one fluid outlet 106. The central flow axis 119 may be substantially parallel to the longitudinal direction L in the inlet section 110 of the at least one flow channel 108. The inlet section 110 may have a substantially constant width that extends substantially perpendicular to the central flow axis 119. In an aspect, the width extends in the transverse direction T.

FIG. 1C illustrates a cross-sectional view of the system 100 taken along line A-A shown in FIG. 1A. The inlet section 110 is defined by a bottom wall 156, a first side wall 158, and a second side wall 160. The inlet section 110 can define a substantially constant cross-sectional area 154. The cross-sectional area 154 may extend in the vertical direction V from the bottom wall 156 of the inlet section 110 to the top surface 134 of the body 102, and in the transverse direction T from the first side wall 158 of the inlet section 110 to the second side wall 160 of the inlet section 110. The first side wall 158 may be spaced from the second side wall 160 in the transverse direction T by the bottom wall 156 of the inlet section 110. In an aspect, the first and second side walls 158 and 160 are substantially parallel to each other. The first and second side walls 158 and 160 may extend in the vertical direction V from the bottom wall 156 of the inlet section 110 to the top surface 134 of the body 102. The bottom wall 156 may extend in the transverse direction T from the first side wall 158 to the second side wall 160. In an aspect, the bottom wall 156 is substantially perpendicular to the first and second side walls 158 and 160.

FIG. 1D illustrates a cross-sectional view of the system 100 taken along line B-B shown in FIG. 1A. The outlet section 112 of the flow channel extends from the inlet section 110 toward the fluid outlet 106, for example, from the inlet section 110 to a swirl chamber 146. The outlet section 112 is defined by a bottom wall 164, a first side wall 166, and a second side wall 168. The outlet section 112 may have a cross-sectional area 162 that decreases in size from the inlet section 110 toward the fluid outlet 106. The cross-sectional area 162 extends in the vertical direction V from the bottom wall 164 of the outlet section 112 to the top surface 134 of the body 102, and in the transverse direction T from the first side wall 166 of the outlet section 112 to a second side wall 168 of the outlet section 112. The first side wall 166 may be spaced from the second side wall 168 along the transverse direction T by the bottom wall 164 of the outlet portion 132. The first and second side walls 166 and 168 may be substantially parallel to each other in the vertical direction V. The first and second side walls 166 and 168 may extend in the vertical direction V from the bottom wall 164 of the outlet section 112 to the top surface 134 of the body 102. The bottom wall 164 may extend in the transverse direction T from the first side wall 166 to the second side wall 168. The bottom wall 164 can be substantially perpendicular to the first and second side walls 166 and 168.

FIG. 1E illustrates a close up top view of a portion of the body 102 (e.g. box with reference number 11 shown in FIG. 1A). The outlet section 112 further includes a side chamber wall 174 that defines a swirl chamber 146. The swirl chamber 146 extends about a vertical axis 170. The vertical axis 170 extends in the vertical direction V through a center 172 of the fluid outlet 106. The swirl chamber 146 may comprise a cylindrical shape, extending in the vertical direction V from a bottom surface 135 of the swirl chamber 146 to the fluid outlet 106 defined by the top surface 134 of the body 102. In an aspect, the swirl chamber 146 has a height in the vertical direction V that is less than a height in the vertical direction V of at least one of the inlet and outlet sections 110 and 112 leading to the swirl chamber 146. In an aspect, at least a portion of the side chamber wall 174 intersects tangentially the first side wall 166 of the outlet section 112. In an aspect, the first side wall 166 is colinear with the side chamber wall 174.

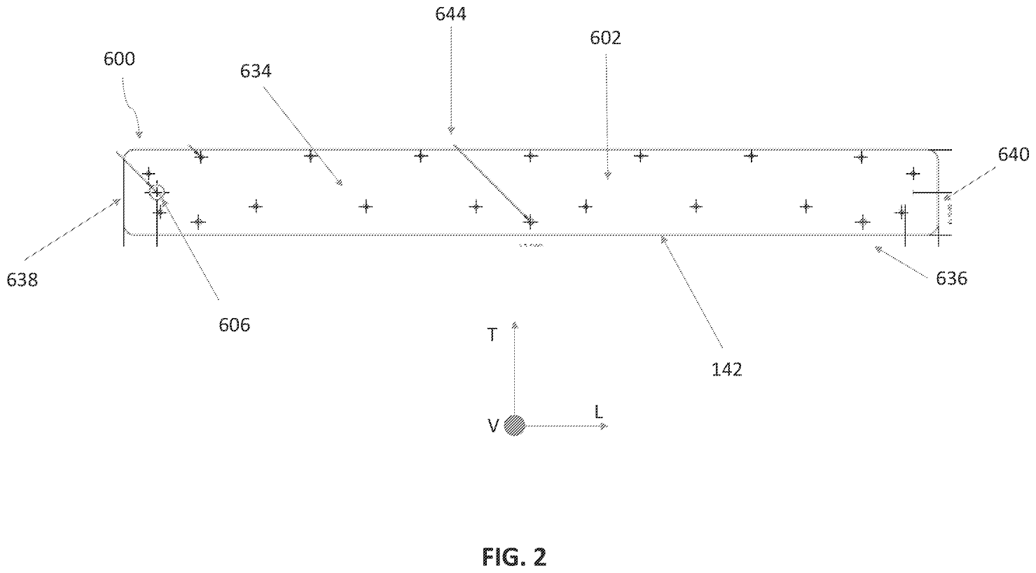

FIG. 2 illustrates a cover 600, according to an aspect of this disclosure. The cover 600 includes a body 602 defined by a first surface 634 and a second surface 636 spaced from the first surface 634 in the vertical direction V. The body 602 has a first side surface 638 and a second side surface 640 spaced from the first side surface 638 in the longitudinal direction L. The body 602 further has a third side surface 642 and a fourth side surface 644 spaced from the third side surface 642 in the transverse direction T. At least one of the first and second surfaces 634 and 636 is configured to be coupled to the top surface 134 of the spray system 100. The cover 600 may be integrated into to the spray system 100 such that the cover 600 and spray system 100 form one unitary item, for example, by three-dimensional (3D) printing. Alternatively, the cover 600 may be coupled to the spray system 100 using fasteners, adhesive, or any other means appropriate to keep the cover 600 and spray system 100 coupled to each other.

The cover 600 defines at least one opening 606 (e.g. fluid outlet), such as one opening 606 or two openings (not pictured). The at least one opening 606 may be cylindrical in shape, extending in the vertical direction V from the first 634 to the second surface 636 of the cover. The at least one opening 606 may be at or near the at least one fluid outlet 106 in the longitudinal L and transverse T directions, for example, a vertical axis extending through a center of a fluid outlet 106 may additionally extend through a center of an opening 606. The number of openings may correspond to the number of fluid outlets 106 of the body 102 of the spray system 100. For example, when the cover 600 is coupled to the body 102, a fluid may flow through the spray system 100, entering through the at least one fluid inlet 104, traveling through the at least one flow channel 108, exiting the body 102 via the at least one fluid outlet 106, and passing through the opening 606 towards the environment 190. After entering the spray system 100, the fluid may transform to a turbulent vortex to create a spray of droplets exiting from an opening 606.

The outlet section 112 of the flow channel 108 may be configured such that a fluid pressure increases when fluid enters the outlet section 112 from the inlet section 110, thereby facilitating the creation of a turbulent vortex. A turbulent vortex created in the outlet section 112 may cause the fluid to pass through the fluid outlet 106 to the environment 190 in a conical shape at a conical angle θ. The conical angle θ may range from approximately 45 degrees to approximately 120 degrees depending on various design considerations, such as the distance from the fluid outlet 106 to the targeted surface or flame. For example, the conical angle may be approximately: 45 degrees, 60 degrees, 90 degrees, or 120 degrees. Generally, a conical angle θ towards 45 degrees is preferred when the targeted surface is at a further distance from a target, and a conical angle θ towards 120 degrees is preferred when the targeted surface is at a closer distance to the target. It should be appreciated that the fluid outlet 106 can define a variety of spray patterns, where each particular spray pattern is determined based upon the environment in which that particular fixed fire extinguishing system 10 is installed, as well as the intended spray area and pattern of the fluid. Additionally, or alternatively, the creation of the turbulent vortex may begin in the outlet section 112. The turbulent vortex can pass into the swirl chamber 146 at or near a location where the first side wall 166 of the outlet section 112 connects to the side chamber wall 174 of the swirl chamber 146. More specifically, the turbulent vortex passes into the swirl chamber 146, wherein a centrifugal force is generated, allowing the turbulent vortex to conform to the circular shape of the chamber wall 174. From the swirl chamber 146, the fluid flowing as a turbulent vortex exits the body 102 to the environment 176 via the fluid outlet 106.

To create the turbulent vortex, the pressure of the fluid entering the outlet section 112 may range from about 25 psig to about 100 psig. It should be appreciated that the pressure of the fluid entering the outlet section 112 may be beyond the about 25 psig to about 100 psig range depending on the specific construction of the spray system 100, including the number of fluid inlets 104, fluid outlets 106, flow channels 108, and the cross-sectional areas 154 and 162 of the inlet and outlet portions 130 and 132. For effectiveness and efficiency, the fluid can be emitted in the smallest droplet size possible yet large enough not to be affected by drift, the displacement of fluid by heat rise, wind, or other factors that can affect the fluid landing on the fire. In an aspect, the droplet size ranges from about 150 microns to about 500 microns, wherein any particular spray pattern may have droplet sizes spanning the entire 150 to 500-micron range, or any subset thereof. Volume and spray pattern can be regulated by the fluid outlet 106 opening or an opening 606 of a cover 600. For example, the smaller the diameter of the openings 606, the less volume of fire suppressant material is emitted from the spray system 100. The stronger the pump 30 used, the more pressure is applied to the fluid and the more volume is emitted. The fire extinguishing system 10 may further include a plurality of interchangeable nozzles 32 attachable at the fluid outlet 106 or the opening 606 that can be interchanged as desired by the operator.

The chamber wall 174 of the swirl chamber 146 comprises an upper chamber wall 176, wherein the upper chamber wall 176 comprises a portion of the chamber wall 174 and extends between the bottom surface 135 of the swirl chamber 146 and the top surface 134 of the body 102. The upper chamber wall 176 may include at least one spoke 178, wherein the at least one spoke 178 extends from a first location 180 on the upper chamber wall 176 to a second location 182 on the upper chamber wall 176 through the vertical axis 170 of the swirl chamber 146. The first and second locations 180 and 182 on the upper chamber wall 176 that define the extension of the at least one spoke 178 may be at substantially the same vertical position within the swirl chamber 146. For example, the at least one spoke 178 may extend in the longitudinal direction L, the transverse direction T, or a combination thereof, and may not extend substantially in the vertical direction V. In an alternative aspect, the at least one spoke 178 can extend in the vertical direction V from the bottom surface 135 of the swirl chamber 146. The at least one spoke 178 can extend between locations on the upper chamber wall 176 (e.g. the at least one spoke 178 can be spaced from the upper chamber wall 176) in the longitudinal direction L, the transverse direction T, or combinations thereof.

The at least one spoke 178 may include, for example, three spokes 178, wherein the three spokes are spaced substantially equally around the upper chamber wall 176 by an angle Φ at substantially the same vertical position within the swirl chamber, where each spoke extends through the vertical axis 170 of the swirl chamber 146. Measured in degrees, the angle Φ may be determined by dividing 360 degrees by double the number of spokes 178. For example, if the swirl chamber includes three spokes, the angle Φ between spokes 178 would be approximately 60 degrees. It should be appreciated, however, that spokes 178 may be arranged in any arrangement according to design needs. In an aspect, the at least one spoke 178 causes a disruption of the turbulent vortex, causing at least some of the fluid comprising the turbulent vortex to flow towards the center 172 of the fluid outlet 106 that results in a more uniform conical spray pattern.

The fire suppressant used in the system 100 can include water. It will be appreciated that other fire suppressants suitable for extinguishing a fire can be used. For example, the fire suppressant can be a liquid, powder, or foam (such as Pyrocool) to put out a grease fire, oil fire, or other type of fire in which the efficacy of water is limited. The fire suppressant can be a commercially manufactured liquid that when mixed with water at a 4% dilution (though other dilution percentages are contemplated) creates a fire suppressant material suitable for all classifications of fire. The fire suppressant can also at least partially comprise a marker or specialized fluid usable as a forensic tool. One type of fire suppressant includes unique markers that are used to track spray patterns. One specific type of fire suppressant that can be utilized is fire extinguishing foam (FEF) fire-fighting foam, which meets a wide range of firefighting challenges, including industrial, marine, mining, municipal, oil, petrochemical, and transportation.

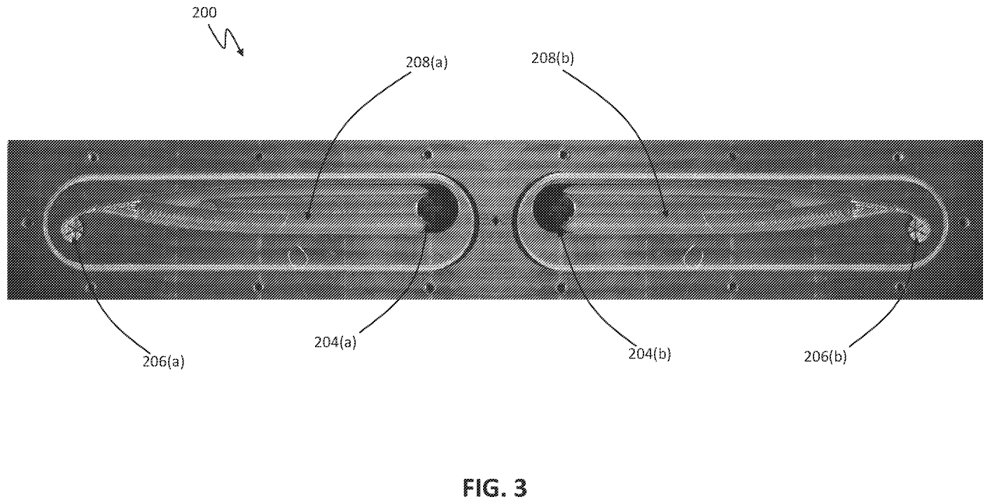

FIG. 3 is a top view of another aspect of a spray system 200. The spray system 200 includes a body 202 that defines first and second flow channels 208(a) and 208(b), first and second fluid inlets 204(a) and 204(b), and first and second fluid outlets 206(a) and 206(b). Fluid may enter the spray system 200 via the first fluid inlet 204(a), through the first flow channel 208(a), and exit the spray system 200 via the first fluid outlet 206(a), constituting a first flow path. Additionally, or alternatively, fluid may enter the spray system 200 via the second fluid inlet 204(b), through the second flow channel 208(b), and exit the spray system 200 via the second fluid outlet 206(b), constituting a second flow path. The first and second flow paths spaced from each other along the central axis 218 in the longitudinal direction L. Alternatively, the first and second flow paths may be spaced from each other in the transverse direction T.

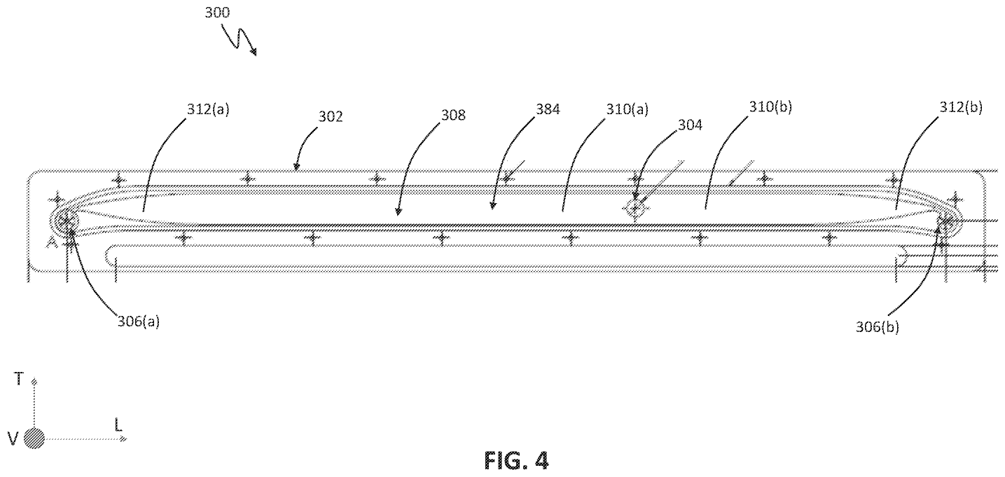

FIG. 4 illustrates a top view of a spray system 300, according to another aspect of the disclosure. The spray system includes a body 302 that defines a single flow channel 308, a single fluid inlet 304, and first and second fluid outlets 306(a) and 306(b). The fluid inlet 304 and the first and second fluid outlets 306(a) and 306(b) may be spaced from each other at least along the central flow axis 319. The fluid inlet 304 may be positioned between the first and second fluid outlets 306(a) and 306(b) along the central flow axis 319. The fluid inlet 304 may be further spaced from both the first and second fluid outlets 306(a) and 306(b) in the vertical direction V. The flow channel 308 may further comprise a midpoint 384 that is equidistant along the flow channel 308 in the longitudinal direction L between the first and second fluid outlets 306(a) and 306(b). The fluid inlet 304 may be offset along the flow channel 308 from the midpoint 384, or the fluid inlet 304 may be positioned at about the same longitudinal position along the flow channel as the midpoint 384. The flow channel includes first and second sections 386 and 388, wherein each of the first and second sections includes an inlet section 310(a) and 310(b), and an outlet section 312(a) and 312(b). Fluid may enter the spray system 300 via the fluid inlet 304, into the flow channel 308 flowing in the first and/or second section 386 and 388 towards either first and/or second fluid outlet 306(a) and 306(b), respectively, and exit the spray system 300 via the first and second fluid outlets 306(a) and/or 306(b) towards the environment 390.

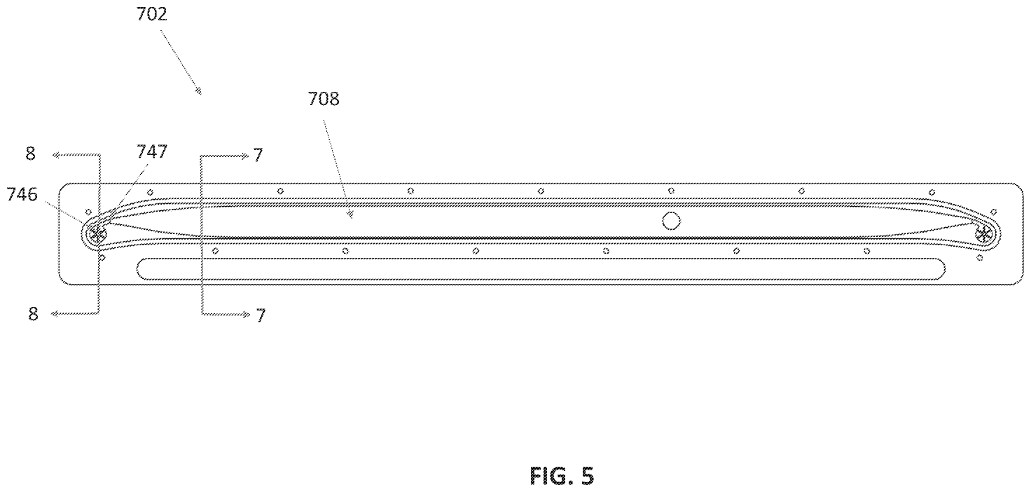

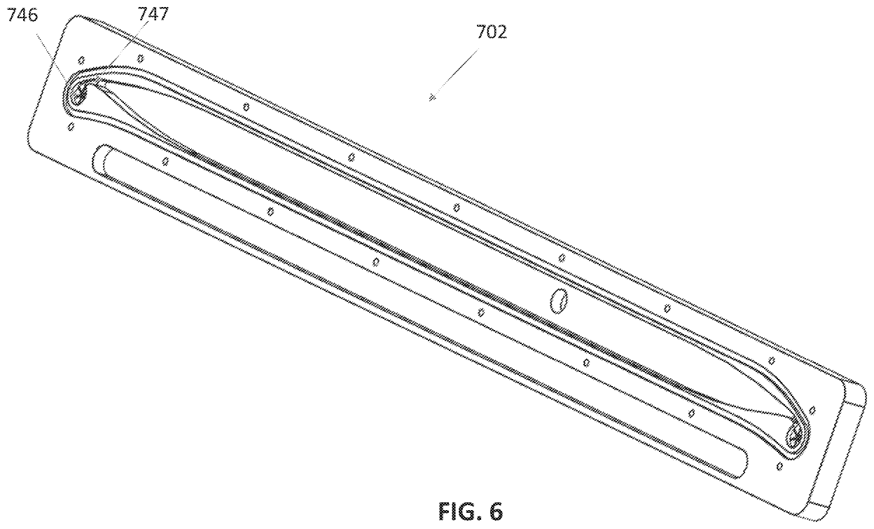

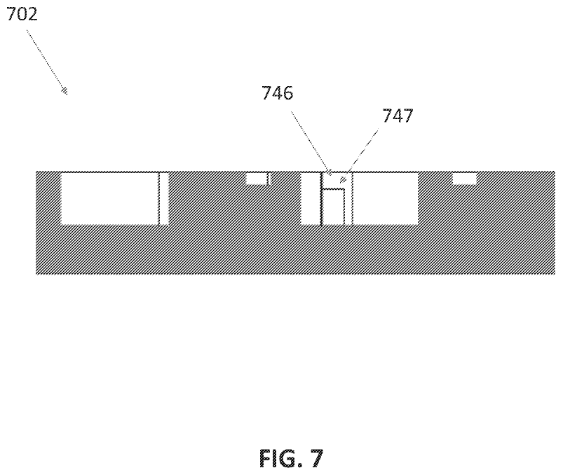

FIGS. 5-8 illustrate an alternate aspect of a body 702 of a spray system, according to an aspect of this disclosure. The body 702 includes a swirl chamber 746 that has an opening 747 that opens to a flow channel 708. The swirl chamber 746 may have a height (extending into the page in FIG. 5) that is less than a height of the flow channel 708. The swirl chamber 746 can include at least one spoke 778 defined by a bottom surface 735 of the swirl chamber 746. The at least one spoke 778 can include recesses, depressions, or other contours that extend below the bottom surface 735 of the swirl chamber 746.

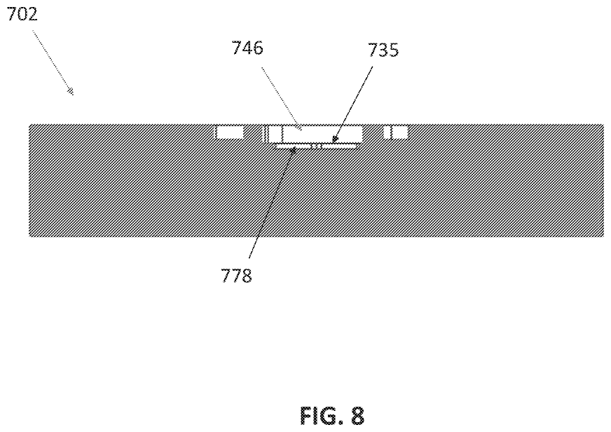

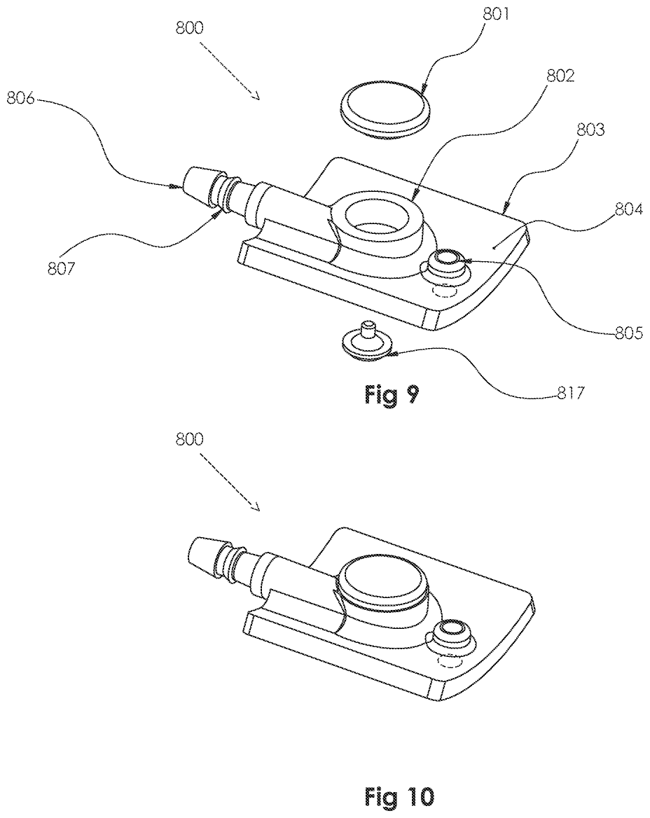

FIGS. 9 and 10 illustrate an exploded perspective view and a collapsed perspective view, respectively, of a nozzle assembly 800, according to an aspect of this disclosure. The nozzle assembly 800 includes a cap 801 and a main nozzle body 803. The nozzle assembly 800 is shaped to mold a curved surface 804 onto the body 803 of that conforms to a given curvature. In an aspect, the surface 804 is curved concentrically with the radius of a housing to which the nozzle body 803 is mounted in order to enable the body 803 to slide and adjust its angle of spray relative to a horizon. A screw (not shown) can secure the nozzle body 803 to the housing of the device using a threaded hole 805. The threaded hole 805 can be used to, for example, either secure the nozzle body 803 to a device, control adjustability, or secure something from the opposite side to the nozzle body 803. The nozzle body 803 can include a single threaded hole 805. Alternatively, the nozzle body 803 can include multiple threaded holes 805.

A cap 801 can be inserted into a cavity of a nozzle outlet body 802. The nozzle outlet body 802 can extend through the nozzle body 803 from an upper opening to a nozzle outlet 809 (e.g. outlet opening). It will be appreciated that the nozzle body 803 can include more than one nozzle outlets 809 for allowing fluid to exit the nozzle assembly 800. The cap 801 can be secured within the upper opening of the outlet body 802 by, for example, radio frequency (RF) welding, adhesives, or other joining processes or materials.

The nozzle assembly 800 further includes at least one barb 807 designed into a nozzle inlet body 806 to retain a hose (not shown) connected to the inlet body 806. The inlet body 806 is fluidly connected to the outlet body 802 as further described below.

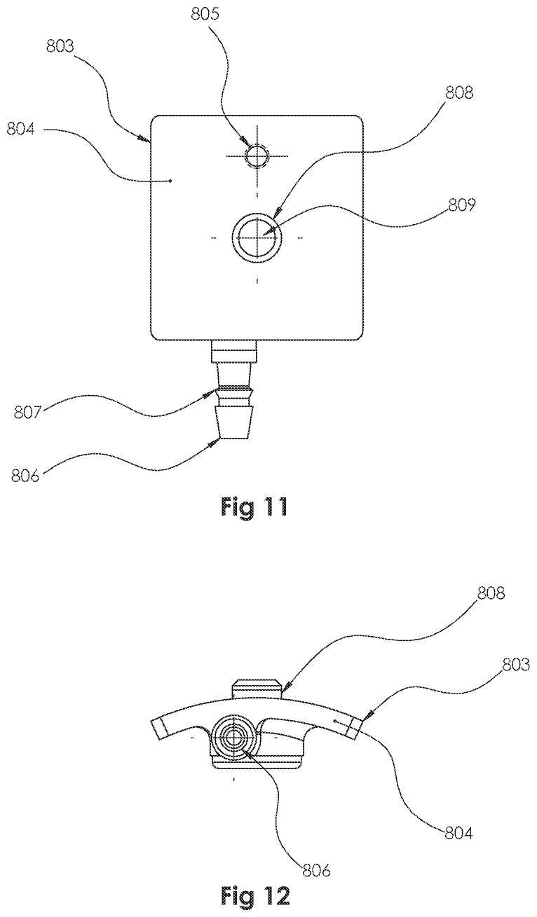

FIG. 11 illustrates a bottom view of the nozzle assembly 800, and FIG. 12 illustrates a side view of the nozzle assembly 800. The nozzle outlet 809 can include locating boss 808 surrounding the outlet 809. The locating boss 808 can be larger (e.g. greater cross-sectional dimension) than the nozzle outlet 809 that protrudes from the curved surface 804. The locating boss 808 can be used to track the outlet body 802 into a specific groove in the housing it is mounted to in order to keep it located in a desired position or path. The locating boss 808 can be larger than the outlet 809 such that it does not interfere with a spray pattern coming out of the outlet 809. The locating boss 808 can be integrated into the nozzle body 803 about the outlet 809. The locating boss 808 can include various shapes, for example, cylindrical, rectangular, elliptical, combinations thereof, or still other shapes.

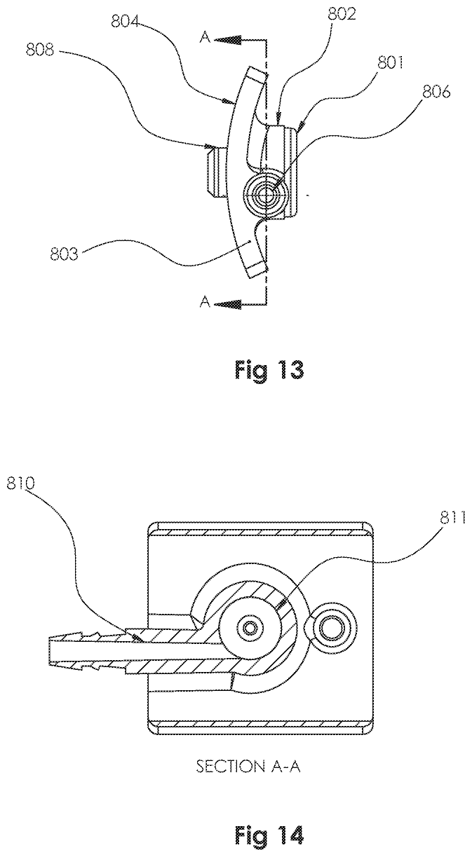

FIG. 13 illustrates another side view of the nozzle assembly 800, and FIG. 14 illustrates a cross-sectional view of the nozzle assembly 800 taken along line A-A in FIG. 13. The inlet body 806 includes an inlet surface 810 that defines an inlet fluid channel within the inlet body 806. In an aspect, the inlet fluid channel is tapered until it reaches an inner chamber 811 (e.g. outlet chamber). A benefit of the tapered fluid channel is that it can facilitate injection molding of the nozzle assembly 800. The inlet fluid channel extends about an inlet flow axis through the inlet body 806 from an inlet opening to a chamber opening 820 (see FIG. 16). The inlet fluid channel is in fluid communication with the inner chamber 811 via the chamber opening 820.

The nozzle body 802 includes an outlet surface that defines at least a portion of the inner chamber 811. The nozzle body 802 can also include a chamber surface. In an aspect, the chamber surface is defined by the cap 801. The inner chamber 811 extends about an outlet flow axis from the chamber surface toward an outlet fluid channel 813. The outlet flow axis extending through a center of the inner chamber 811. The outlet fluid channel 813 can also extend about the outlet flow axis. The outlet fluid channel 813 extends from the nozzle outlet 809 toward the inner chamber 811.

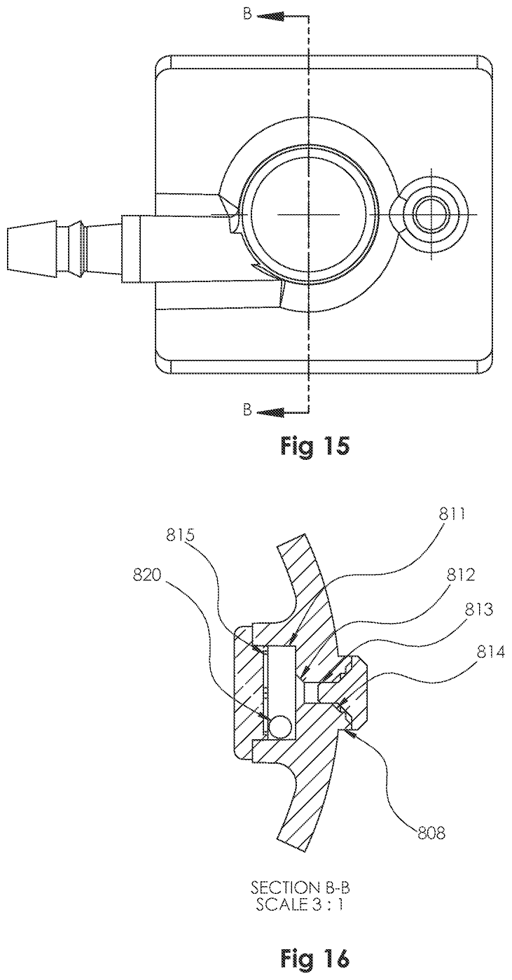

FIG. 16 illustrates a cross-sectional view of the nozzle assembly 800 taken along line B-B shown in FIG. 15. In an aspect, the nozzle body 802 further defines an inner conical chamfer channel 812 between the inner chamber 811 and the outlet fluid channel 813. The nozzle body 802 can further define an external conical chamfer channel 814. Th external conical chamfer channel 814 extends from the outlet fluid channel 813 to the nozzle outlet 809. The inner chamber 811 is fluidly connected to the nozzle outlet 809 via the inner chamfer channel 812, outlet fluid channel 813, and the external chamfer channel 814.

When the spray system 100 is activated, fluid can flow through the nozzle assembly 800 through the inlet channel of the nozzle inlet 806, the inner chamber 811, and outlet fluid channel 813, and out through the nozzle outlet 809. The inlet channel is configured such that the fluid is propelled into the inner chamber 811 along the outlet surface of the inner chamber 811. For example, the inlet flow axis is offset from the outlet flow axis. The offset between the axes can facilitate the creation of a turbulence in the liquid, which can affect the spray pattern of the fluid exiting the nozzle outlet 809. In an aspect, the inlet flow axis is substantially perpendicular to the outlet flow axis. Additionally, or alternatively, the inlet flow axis is spaced from (e.g. does not intersect) the outlet flow axis.

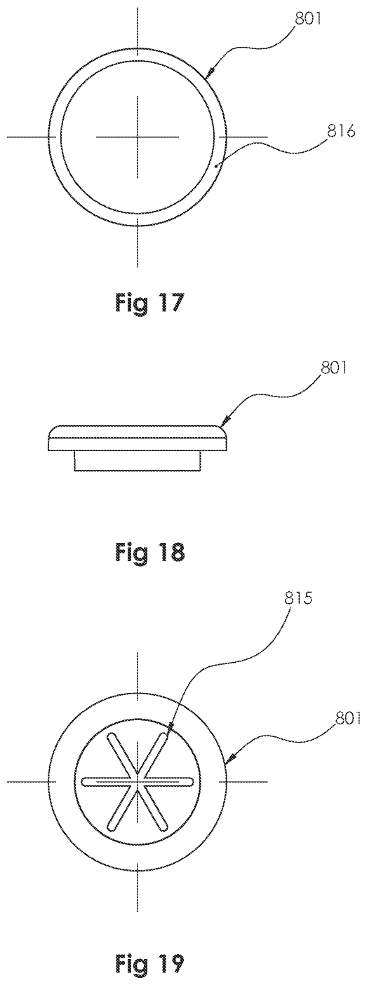

FIGS. 17-19 illustrate a top view, a side view, and a bottom view, respectively, of the cap 801. In an aspect, the cap 801 includes the chamber surface. The cap 801 includes a cap wall 816. With reference to FIG. 19, the chamber surface defines at least one spoke 815. The at least one spoke 815 can be recessed within the chamber surface of the cap 801. Each spoke 815 extends between first and second locations on the chamber surface. In an aspect, each spoke 815 extends through the outlet flow axis. The at least one spoke 815 can include a plurality of spokes. Each of the plurality of spokes can be angularly offset from each of the other plurality of spokes 815 by a substantially equal angle. As illustrated in FIG. 19, the chamber surface defines three spokes 815. It will be appreciated that fewer or more spokes can be defined by the chamber surface.

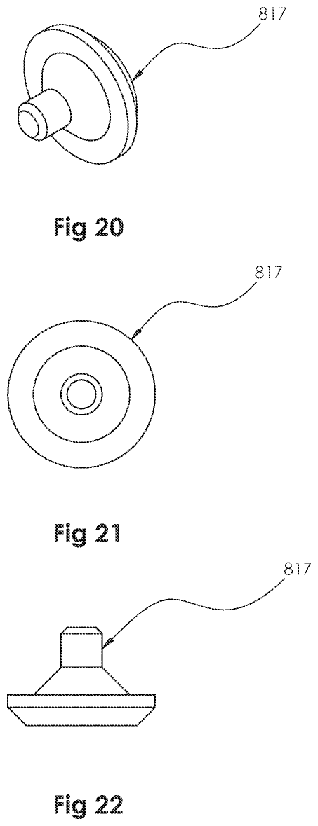

FIGS. 20-22 illustrate a perspective view, a top view, and a side view of a nozzle plug 817, according to aspects of this disclosure. The plug 817 is sized to be positioned within the nozzle outlet 809. The plug 817 can combat the build-up of grease and various other materials that can inadvertently be collected in the nozzle outlet 809 over time through the use of, for example, a stovetop positioned below the nozzle assembly 800. The plug 817 can comprise rubber, or other material, configured to hold the plug 817 within the nozzle outlet 809 until the spray system 100 is activated. The plug 817 can comprise other materials including, for example, PVC, plastic, combination of materials such as a PVC plug with a rubber ring, or still other materials capable of releasably retaining the plug 817 within the nozzle outlet 809. After the spray system 100 is activated, fluid pressure provided through the nozzle assembly 800 can push the plug 817 out of the nozzle outlet 809 and allow fluid (e.g. suppressant) to freely flow from the inlet opening of the inlet body 806 through the nozzle assembly 800 an out through the nozzle outlet 809

Alternatively, the plug 817 can blow off upon activation of the spray system 100. The plug 817 can comprise, for example, a foil cover to seal the nozzle or a replaceable plug that has a retainer that fits into or onto the nozzle as a cap and blows off upon activation. It will be appreciated that other alternatives are possible to ensure a clear path for the fluid to flow through the nozzle assembly 800 and to withstand daily accumulation of grease and other matter that accumulates on the spray system 100.

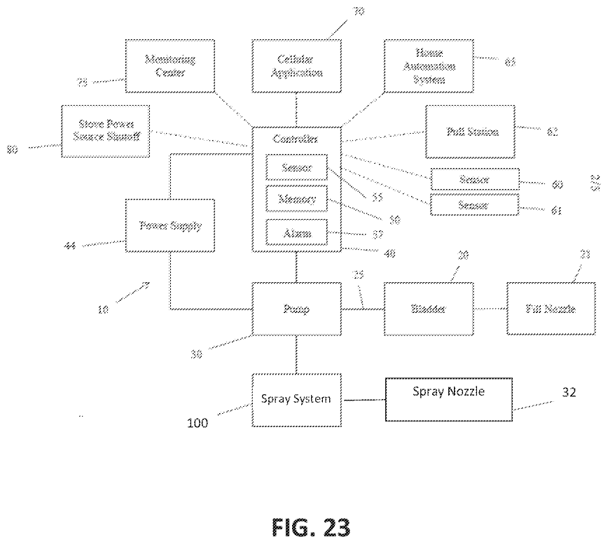

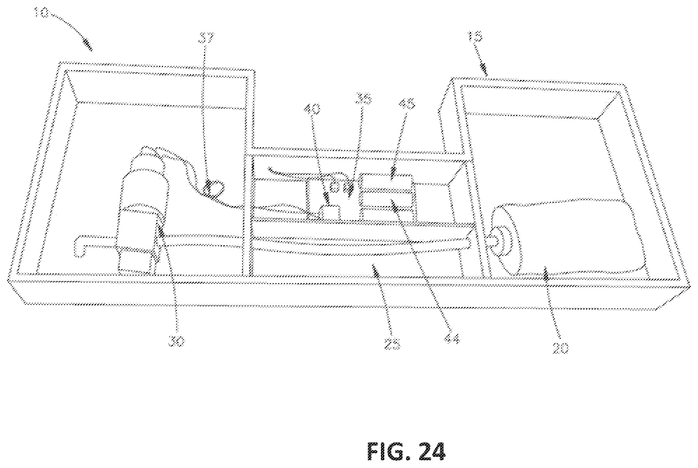

As illustrated in FIGS. 23 and 24, the spray system 100 is a component of a fixed fire extinguishing system 10 that further includes a pump 30 attached to a bladder 20 via tubes 25. The pump 30 functions to flow fluid from the bladder 20, through the tubes 25, and out of spray system 100. The pump 30 may further function to flow fluid through the opening 606 of a cover 600 and/or a nozzle 32. The pump 30 can be any type of electric pump capable of actuating the flow of fluid from the bladder 20, through the tubes 25, and out of the spray system 100. The tubes 25 can be comprised of metal, or alternatively can be comprised of a flexible polymer. The fittings of the tubes 25 may be secured with shrink tubes, and portions of the tubes 25 may be connected via quick connect fittings. The tubes 25 can connect the pump 30 to the bladder 20, as well as the pump 30 to the spray system 100. In one embodiment, the spray system 100 is integral with a housing 15. Alternatively, the spray system 100 is releasably attached to the housing 15, such as through a threaded engagement. The spray system 100 can also include a barbed fitting that is configured to engage either the housing 15 or the tubes 25, such that the spray system 100 is easily attachable to the fixed fire extinguishing system 10.

The pump 30 receives power from a power supply 44. The power supply 44 may include batteries 45 or a wired connection to an external power source, such as an electrical outlet. However, the power supply 44 may include both batteries 45 and a wired connection as a redundancy to prevent a loss of power through depleted batteries or electrical outage. The power supply 44 may also power a controller 40 connected to circuit board 35 that controls operation of the pump 30. The power supply 44 can include a first power supply and a second power supply. The first power supply power to the controller 40, and the second power supply can provide power to an actuator (as further described below).

The controller 40 can be connected to the pump 30 through wires 37. The controller 40 may be in electronic communication with a sensor 60 that notifies the controller when a condition indicative of a fire has been encountered. For example, the sensor 60 can be a temperature sensor or a humidity sensor. The sensor 60 can include more than one sensor, such as two sensors for redundancy. When the sensor 60 includes more than one sensor, the sensors may be of the same or different types. The controller 40 can be configured to receive a user input that alters the threshold conditions in which the controller will determine that a signal received from the sensor 60 is indicative of a fire. For example, the controller 40 may be initially programmed such that a temperature reading of at least about 195 degrees Fahrenheit by the sensor 60 indicates the presence of a fire. A user may provide an input to the controller that lowers the temperature at which the controller 40 will determine that a fire is present to about 135 degrees Fahrenheit, or raises the temperature at which the controller 40 will determine that a fire is present to about 250 degrees Fahrenheit.

In operation, the fire extinguishing system 10 may be in an initial unactuated state, in which the pump 30 is inactive and no fire suppressant flows through the tubes 25 and out of the nozzle 32. However, at one point the sensor 60 may sense a condition that the controller 40 determines is indicative of a fire, such as an elevated temperature. At this time, the controller 40 directs the pump 30 to activate and force fire suppressant from the bladder through the tubes 25, and out of the nozzle 32. The bladder 20 can be refillable with fire suppressant material from an external supply (not shown) without dismantling the housing 15 and replacing the bladder 20.

Referring to FIG. 23, the AMDS 10 can further be in communication with a home automation system 65. The home automation system 65 can be any conventional type of home automation system, and can be configured to control and monitor various other residential or business features in addition to the AMDS 10, such as lights, entry alarms, thermostats, locks, or still other features. The AMDS 10 can be integrated with the home automation system 65 either through wires or wirelessly, which allows a user to control or monitor the AMDS 10 through a hub or other user input of the home automation system 65. When wirelessly connected, the wireless communication between the home automation system 65 and the AMDS 10, particularly the controller 40, can be performed via ZigBee, Z-wave, Bluetooth, Wi-Fi, or radio waves. For example, a user can use the home automation system 65 to monitor such information related to the AMDS 10 as the status of the power supply 44, amount of fire suppressant in the bladder 20, parameters sensed by the sensor 60 and/or 61, and mode (active or inactive) of the pump 30. Additionally, a user can update settings of the AMDS 10 through a user input of the home automation system 65, such as the predetermined threshold for a parameter that indicates the presence of a fire or the mode of operation of the pump 30.

The AMDS 10 may also send notifications to the home automation system 65. For example, a notification to indicate the state of the communications link between the AMDS 10 and home automation system 65 or a notification that a fire has been detected and the fire suppressant has been activated. As an example, consider the AMDS 10 being in communication with the home automation system 65 using Z-wave communications. The Z-wave communications command classes can provide a means of communicating between a Z-wave hub and a Z-wave enabled device such as the AMDS 10. Command classes provide a means for the AMDS 10 to be configured with various parameters and include such commands as a Configuration Set command or a Configuration Bulk Set command and the parameters may be read using a Configuration Get command or a Configuration Bulk Get command and the parameters may be reported using a Configuration Report message or a Configuration Bulk Report message.

Additionally, notification commands can also be supported to enable reporting of the status of the AMDS 10. The notification commands can be configured using the configuration commands described herein and the notifications can report the status of the AMDS 10 using a Notification Report message. Notifications can be enabled or disabled using a Notification Set command and the state of a notification may be obtained using a Notification Get command through which the Notification Report message would indicate the status of a particular notification. An example of a notification can be a “heartbeat” signal that reports a status of the AMDS 10 on a periodic basis and may be used as an indication of the quality of the communications link between the AMDS 10 and the hub. Another notification can include an indication of a fire and activation of the fire suppressant to put out the fire.

Like the home automation system 65, the AMDS 10 can also be in communication with a cellular application 70. The cellular application 70 can be specifically suited for cellular devices, or can be configured to operate on any type of electronic device, such as a tablet, laptop, PC, or other electronic device. The cellular application 70 can also be specifically designed to monitor the AMDS 10, or can be a third party application configured to integrate with the AMDS 10. Connection to the AMDS 10 with a cellular application 70 also allows multiple users to monitor and/or control the AMDS 10 at once. Connection to a cellular application 70 can be done through any form of wireless communication, such as via ZigBee, Z-wave, Bluetooth, Wi-Fi, or radio waves. Like the home automation system 65, a user can use the cellular application 70 to monitor information related to the AMDs 10 and/or update settings of the AMDs 10 through the user interface (not shown) of the cellular application 70.

Further, the AMDS 10 can be in communication with a monitoring center 75 either through direct communications, via a hub, or the home automation system 65. The monitoring center 75 can be a third party service that monitors a plurality of AMDS 10 across many locations, or can be the dispatch center for first responders. Like the home automation system 65 and the cellular application 70, the connection between the AMDS 10 and the monitoring center 75 can be wireless, and can be performed using via ZigBee, Z-wave, Bluetooth, Wi-Fi, or radio waves. Alternatively, the connection can be wired through conventional electrical wires or fiber optic cable. When the monitoring center 75 receives a signal from the controller 40 that the sensor 60 has detected a parameter that the controller 40 determines indicates the presence of a fire, the monitoring center 75 can contact the owner of the AMDS 10, as well as notify the nearest fire department in order to dispatch first responders to the location of the AMDS 10. Optionally, if the owner notifies the monitoring center 75 that the notification was a false alarm, the monitoring center 75 may not contact the fire department.

The AMDS 10 can also include a stove power source shutoff 80 that is in electrical or fluid communication with the power source of a residential or commercial stove. The stove power source shutoff 80 can comprise a valve, a switch, or other means for cutting off power to a stove when the controller 40 determines that the sensor 60 has detected a parameter indicative of a fire. As such, the stove power source shutoff 80 can be utilized with both electric and gas-powered ranges. In addition to dispensing fire suppressant from the nozzle 32, this functionality allows the AMDS 10 to ensure that the initial cause of the fire, whether it is burnt food or grease, is not provided more fuel. In one embodiment, the controller 40 automatically activates the stove power source shutoff 80 when the controller 40 determines that the sensor 60 has detected a parameter indicative of a fire. Additionally, the AMDS 10 can allow a remote user to manually activate the stove power source shutoff 80 remotely, which can be performed using the pull station 62, home automation system 65, cellular application 70, monitoring center 75, or through a user input (not shown) on the housing 15 of the AMDS 10 itself.

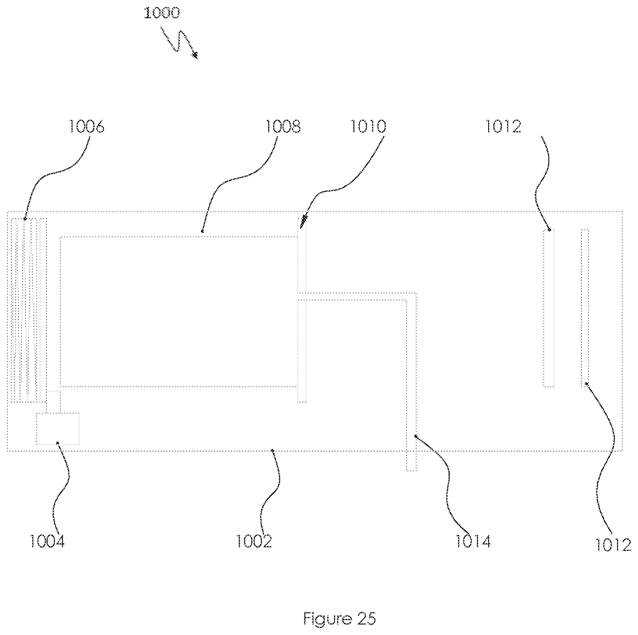

FIG. 25 illustrates a schematic of a spray system 1000, according to an alternative aspect of this disclosure. The spray system 1000 includes an alternative form of energy to dispense fire suppressant. An alternative form of energy can include, for example, mechanical energy, potential energy, energy released from a chemical reaction, combinations thereof, or still other energy sources. The alternative forms of energy can reduce electrical energy and thus for a battery powered device, smaller batteries may be used and an electrical pump may not be required. Alternate mechanisms of releasing the fire suppressant can require less electrical energy to trigger, for example, a solenoid than an electric pump.

The spray system 1000 includes a housing 1002, a fire suppressant delivery device (FSDD) 1004, a biasing member 1006, suppressant container 1008, a wall 1010, a circuit board 1012, and tubing 1014. The FSDD 1004 can comprise an actuator. The circuit board 1012 can control operation of the FSDD 1004. The biasing member 1006 is connected to the suppressant container 1008 such that a biasing force (e.g. mechanical energy source) can be provided by the biasing member 1006 to the suppressant container 1008. The biasing member 1006 can be compressed and locked into place by a latch member (not labelled) connected to the actuator 1004. The actuator 1004 can include, for example, a solenoid. Upon actuation of the spray system, the actuator 1004 can be controlled to release the latch. For example, the circuit board 1012 can send a signal to the actuator 1004 to retract the latch and release the biasing member 1006 when a fire condition is detected. After the latch is released, the mechanical energy of the biasing member 1006 is applied to the suppressant container 1008. The suppressant container 1008 can be fluidly connected to one or more dispensing nozzles via the tubing 1014. The biasing force applied to the suppressant container 1008 can create an internal pressure within the container 1008 causing suppressant stored within the container 1008 to flow through the tubing 1014 and to dispense out through a nozzle or into an inlet (e.g. fluid inlet/s 104 the nozzle/s.

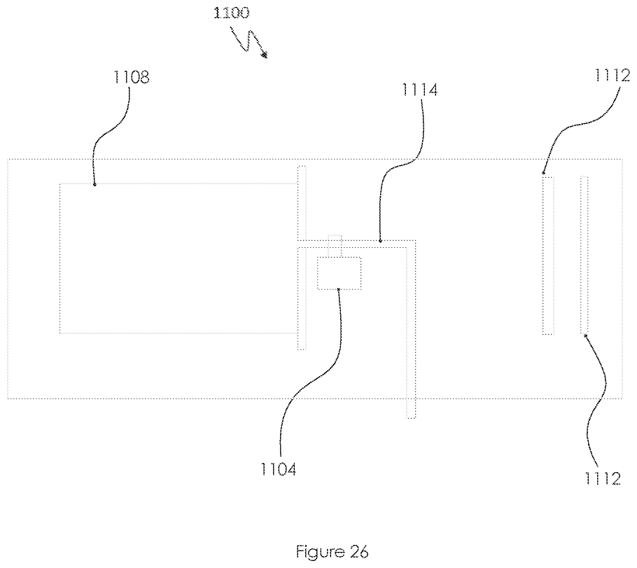

FIG. 26 illustrates a schematic of a spray system 1100, according to another alternative aspect of this disclosure. The spray system 1100 includes an FSDD 1104 that comprises an actuator, a suppressant container 1108, a circuit board 1112, and tubing 1114. In an aspect, the suppressant container 1108 is filled and pressurized at the time of filling the suppressant within the container 1108 during an assembly process. The pressurized container 1108 can create an internal potential energy that can be activated by opening or releasing the suppressant from the container 1108. For example, the container 1108 can be connected to a dispensing nozzle via the tubing 1114. The actuator 1104 can include a valve or other device configured to open and close the tubing 1114. The actuator 1104 can be activated by a signal received from the circuit board 1112 (or controller 40), to transition the actuator 1104 between the open and closed positions. When the actuator 1104 is transitioned to the open position, the internal pressure can push the suppressant material from the container 1108 through the nozzle via the tubing 1114. In an aspect, the suppressant can be pressurized with CO₂. It will be appreciated that other gases or mediums can be used to pressurize the container 1108. A benefit of the system 1100 is that it can require less electrical energy to dispense the suppressant when compared to, for example, an electric pump.

In an aspect, the material state of the suppressant or other material within the suppressant container 1108 can be changed to produce a potential energy within the container 1108. The suppressant or other material within the container 1108 can be changed to a different material state (e.g. liquid, gas, or solid) and captured within the bag during, for example, assembly or setup. Activation can include, for example, transitioning the actuator 1104 to the open position and/or introducing a catalyst to change the material state.

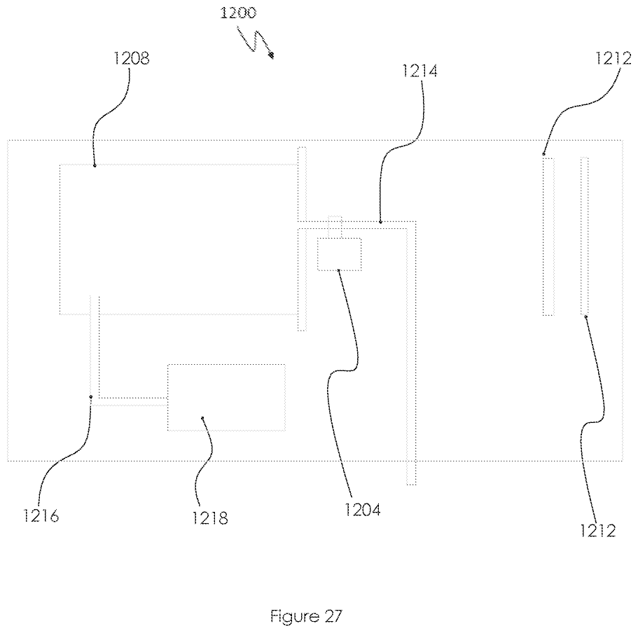

FIG. 27 illustrates a schematic of a spray system 1200, according to another alternative aspect of this disclosure. The spray system 1200 includes an FSDD 1204 that comprises an actuator, a suppressant container 1208, a circuit board 1212, tubing 1214, inlet pressure tubing 1216, and a pressure source 1218. The external pressure source 1218 can create a positive pressure within the container 1208 via the inlet pressure tubing 1216. The positive pressure can be created by, for example, an induced chemical reaction of multiple substances inside or outside the container 1208, a change in temperature to create a positive pressure within the container 1108, combinations thereof, or still other ways to create a positive pressure. When activation of the spray system 1200 occurs, the suppressant container 1208 becomes pressurized from the pressure source 1218. As pressure builds up within the container 1208, the actuator 1204 can transition to the open position and release the suppressant from the container 1208 through the tubing 1214 to the desired location (e.g. nozzle/s). In an aspect, the pressure source 1218 can have a pressure of approximately zero prior to activation of the spray system 1200. Once the spray system 1200 is activated, the pressure source 1218 provides a pressure to the container 1208 and the actuator 1204 is activated.

In an aspect, the AMDS 10 can include a first power supply and a second power supply. The first power supply can be configured to provide power to at least one of the controller 40 and circuit boards 1012, 1112, and 1212. The first power supply can include, for example, a wired connection to an external power source and/or one or more batteries. The second power supply can be electrically connected to the FSDD to provide power to the FSDD. The second power supply can include, for example, one or more batteries. The one or more batteries of the first and second power supplies can be replaceable. It will be appreciated that the first power supply can be separate and distinct from the second power supply, such that if controller 40 and the circuit boards 1012, 1112, and 1212 lose power from the first power supply, the FSDD 1004, 1104, or 1204 can still operate using the second power supply. Similarly, if the FSDD 1004, 1104, or 1204 lose power from the second power supply, the controller 40 and the circuit boards 1012, 1112, and 1212 can still operate using the first power supply.

In an aspect, the demand for power from the second power supply is less than the demand for power from the first power supply. For example, the second power supply can provide power to the FSDD 1004, 1104, or 1204, which can include a solenoid valve or like component. The solenoid valve or like component can operate at, for example, less than a 12 Wh. Whereas the power supply demand from the controller 40 and the circuit boards 1004, 1104, and 1204 can be at least 12 Wh.

Aspects

The following Aspects are illustrative only and do not limit the scope of the present disclosure or the appended claims.

Aspect 1. A spray system comprising:
a body having a first end and a second end spaced from the first end, wherein the body defines:
at least one fluid inlet positioned between the first and second end;
at least one fluid outlet positioned between the at least one inlet and either one of the first end and the second end, the at least one outlet being spaced from the at least one fluid inlet in a vertical direction; and
at least one flow channel extending between the at least one fluid inlet and the at least one fluid outlet along a central flow axis, wherein the at least one fluid inlet is in fluid communication with the at least one fluid outlet via the at least one flow channel, wherein the at least one flow channel includes an inlet section and an outlet section, the inlet section extending from the at least one fluid inlet to the outlet section along the central flow axis, and the outlet section extending from the inlet section to the at least one fluid outlet along the central flow axis, wherein the inlet section has a substantially constant width that extends in a transverse direction, the transverse direction being substantially perpendicular to the vertical direction.

Aspect 2. A spray system according to Aspect 1, wherein the at least one flow channel includes a single flow channel; the at least one fluid inlet includes a single fluid inlet; and the at least one fluid outlet includes a single fluid outlet.

Aspect 3. A spray system according to Aspect 2, wherein the inlet section maintains a constant cross-sectional area between the fluid inlet and the outlet section; wherein the outlet section has an outlet portion that has a cross-sectional area that decreases in size from the inlet section toward the fluid outlet.

Aspect 4. A spray system according to Aspect 3, wherein the outlet section defines a swirl chamber extending about a vertical axis, the vertical axis extending through a center of the fluid outlet, and wherein the outlet portion that decreases in cross-sectional area extends from the inlet section to the swirl chamber.

Aspect 5. A spray system according to Aspect 4, wherein the swirl chamber is defined by a side chamber wall, and wherein the outlet section is defined by a first side wall and a second side wall, the first side wall intersecting tangentially with at least a portion of the side chamber wall.

Aspect 6. A spray system according to Aspect 5, wherein the swirl chamber is further defined by an upper chamber wall, the upper chamber wall including at least on spoke, wherein the at least one spoke extends from a first location on the upper chamber wall to a second location on the upper chamber wall through the vertical axis of the swirl chamber, wherein the first and second locations of the at least one spoke are at substantially the same vertical position within the swirl chamber.

Aspect 7. A spray system according to Aspect 6, wherein the at least one spoke includes three spokes, wherein the three spokes are spaced substantially equal around the upper chamber wall at substantially the same vertical position within the swirl chamber.

Aspect 8. A spray system according to Aspect 5, wherein the outlet section of the flow channel is configured to create a turbulent vortex of a fluid when the fluid enters the outlet section of the flow channel from the inlet section at about 25 psig to about 100 psig.

Aspect 9. A spray system according to Aspect 8, wherein the fluid exits the fluid outlet in a conical shape having a droplet size at a conical angle of approximately 45 degrees to approximately 120 degrees.

Aspect 10. A spray system according to Aspect 9, wherein the droplet size ranges from about 150 microns to about 500 microns.

Aspect 11. A spray system according to Aspect 8, wherein the fluid comprises water and at least one fire-suppressant additive.

Aspect 12. A spray system according to Aspect 1, wherein the at least one flow channel includes one flow channel; the at least one fluid inlet includes one fluid inlet; and the at least one fluid outlet includes two fluid outlets, a first and a second fluid outlet, wherein the first and second fluid outlets and the one fluid inlet are spaced from each other along the central flow axis.

Aspect 13. A spray system according to Aspect 12, wherein the fluid inlet is positioned between the first and second fluid outlet along the central flow axis.

Aspect 14. A spray system according to Aspect 13, wherein the flow channel comprises a midpoint equidistant between the first and second fluid outlets, the fluid inlet being offset from the midpoint along the flow channel.

Aspect 15. The spray system according to Aspect 1, wherein the first end of the body is spaced apart from the second end of the body along a central axis, wherein the central axis is at least partially offset from the central flow axis.

It will be appreciated that the foregoing description provides examples of the disclosed system and method. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

We claim:

1. A spray nozzle for an advanced adjustable density misting delivery system (AMDS) for neutralizing a fire, the spray nozzle comprising:
an inlet body having an inlet surface, the inlet surface defining an inlet fluid channel that extends about an inlet flow axis through the inlet body from an inlet opening to a chamber opening; and
an outlet body having an outlet surface and a chamber surface, the outlet surface defining at least a portion of an outlet chamber and an outlet fluid channel, the outlet chamber extending about an outlet flow axis from the chamber surface toward the outlet fluid channel, the outlet fluid channel extending about the outlet flow axis from an outlet opening toward the outlet chamber,
wherein the inlet fluid channel of the inlet body is in fluid communication with the outlet chamber of the outlet body via the chamber opening, and wherein the inlet flow axis is spaced from the outlet flow axis.

2. The spray nozzle according to claim 1, wherein the inlet surface defines a tapered cylindrical inlet fluid channel such that the inlet opening has an inlet cross-sectional dimension that is greater than a outlet cross-sectional dimension of the chamber opening.

3. The spray nozzle according to claim 1, wherein the outlet body comprises a cylindrical wall and a cap, the cylindrical wall having the outlet surface, and the cap having the chamber surface, wherein the cap is securable to the cylindrical wall.

4. The spray nozzle according to claim 1, wherein the inlet flow axis is substantially perpendicular to the outlet flow axis.

5. The spray nozzle according to claim 1, wherein a cross-sectional dimension of the outlet fluid channel is less than a cross-sectional dimension than the outlet chamber.

6. The spray nozzle according to claim 5, wherein the outlet surface further defines a conical chamfer channel positioned between the outlet chamber and the outlet fluid channel along the outlet flow axis.

7. The spray nozzle according to claim 1, wherein the chamber surface defines at least one recessed spoke, the at least one recessed spoke extending from a first location on the chamber surface to a second location on the chamber surface through the outlet flow axis.

8. The spray nozzle according to claim 7, wherein the at least one recessed spoke includes a plurality of recessed spokes, wherein each of the plurality of recessed spokes angularly offset from each of the other plurality of spokes by a substantially equal angle.

9. The spray nozzle according to claim 1, wherein the inlet body is a first inlet body, the spray nozzle further comprising:
a second inlet body having a second inlet surface, the second inlet surface defining a second inlet fluid channel that extends about a second inlet flow axis through the second inlet body from a second inlet opening to a second chamber opening that opens to the outlet chamber.

10. The spray nozzle according to claim 1, wherein the outlet body is a first outlet body, the spray nozzle further comprising:
a second outlet body having a second outlet surface and a second chamber surface, the second outlet surface defining at least a portion of a second outlet chamber and a second outlet fluid channel, the second outlet chamber extending about a second outlet flow axis from the second chamber surface toward the second outlet fluid channel, the second outlet fluid channel extending about the second outlet flow axis from a second outlet opening toward the second outlet chamber.

11. An adjustable density misting delivery system (AMDS) for detecting and neutralizing a fire, the AMDS comprising:
a vessel containing a fire suppressant material;
a fire suppressant delivery device (FSDD) operatively connected to the vessel;
an energy source configured to apply a force to the fire suppressant material within the vessel;
at least one nozzle in selective fluid communication with the vessel;
a controller electrically connected to the FSDD;
a sensor in communication with the controller, the sensor being configured to detect a parameter that indicates the presence of the fire; and
a first power supply configured to provide power to the controller;
wherein the controller is configured to transition the FSDD from a deactivated state to an activated state when the sensor detects the parameter, such that in the deactivated state the FSDD does not operate, and in the activated state the force applied to the fire suppressant material from the energy source ejects the fire suppressant from the vessel, through the at least one nozzle.

12. The AMDS according to claim 11, further comprising:
a second power supply configured to provide power to the FSDD.

13. The AMDS according to claim 11, wherein the energy source is external to the vessel.

14. The AMDS according to claim 13, wherein the energy source comprises a compressed spring, wherein in the activated state the spring compresses the vessel to eject the fire suppressant from the vessel through the at least one nozzle.

15. The AMDS according to claim 12, wherein the FSDD comprises an actuator operatively connected to the compressed spring, wherein when the controller transitions the FSDD from the deactivated state to the activated state the controller sends a signal to the actuator to transition the actuator from a locked state to an unlocked state, in the locked state the spring is prevented from applying the force to the fire suppressant material, and in the unlocked state the spring applies the force to the fire suppressant material.

16. The AMDS according to claim 15, wherein the second power supply is electrically connected to the actuator.

17. The AMDS according to claim 11, wherein in the deactivated state of the FSDD the energy source prevents fire suppressant from being dispensed, and in the activated state of the FSDD the energy source provides a pressure to the fire suppressant that is greater than zero.

18. The AMDS according to claim 11, wherein the energy source is within the vessel and comprises at least one of compressed CO₂ and a material configured to change state.

19. The AMDS according to claim 18, wherein the AMDS further comprises a tube fluidly connected between the vessel and the at least one nozzle, and wherein the FSDD comprises an valve connected to the tube, wherein when the controller transitions the FSDD from the deactivated state to the activated state the controller sends a signal to the valve to transition the valve from a closed state to an open state, in the closed state the valve prevents the fire suppressant material from flowing from the vessel to the at least one nozzle, and in the open state the valve allows the fire suppressant material to flow from the vessel to the at least one nozzle.

20. The AMDS according to claim 19, wherein the valve comprises a solenoid valve.

21. The AMDS according to claim 12, wherein the second power supply is separate and distinct from the first power supply.

22. The AMDS according to claim 21, the second power supply comprises one or more batteries.

23. The AMDS according to claim 21, wherein the first power supply comprises a wired connection to an external power supply.

24. The AMDS according to claim 21, wherein the one or more batteries is a first one or more batteries, and wherein the first power supply comprises a second one or more batteries.

25. A method for detecting and neutralizing a fire using an adjustable density misting delivery system (AMDS), the method comprising:
detecting a parameter that indicates the presence of the fire;
controlling a fire suppressant delivery device (FSDD) to transition from a deactivated state to an activated state based on the detected parameter, the FSDD being operatively connected to a vessel containing fire suppressant material, wherein in the deactivated state the FSDD does not operate, and wherein in the activated state a force is applied to the fire suppressant by an energy source; and
ejecting the fire suppressant from the vessel through at least one nozzle by the force applied by the energy source.
